(19) United States
(12) Patent Application Publication
(10) Pub. No.: US 2025/0360779 A1
(43) Pub. Date: Nov. 27, 2025

(54) SYSTEM AND METHOD FOR PROVIDING ONE OR MORE THIRD-ROW DOORS FOR A VEHICLE

(71) Applicant: Yemao Huang, Longwood, FL (US)

(72) Inventor: Yemao Huang, Longwood, FL (US)

(21) Appl. No.: 18/672,772

(22) Filed: May 23, 2024

(51) Int. Cl. B60J 5/04

(52) U.S. Cl. CPC B60J 5/0486; B60J 5/0473; B60J 5/0477; B60J 5/06

(57) ABSTRACT

In one or more embodiments, systems and methods for providing one or more third-row doors for a vehicle and a vehicle comprising one or more third-row doors are disclosed. In one or more embodiments, the system and method for providing a third-row door for a vehicle includes a door that is provided as a fourth door on one side of a third row of seats. In one or more embodiments, the system and method for providing one or more third-row doors for a vehicle includes a door that is provided as a third and/or fourth door on one or both sides of the vehicle between a second row of seats and a third row of seats. In one or more embodiments, the vehicle including one or more third-row doors includes at least one third-row door provided for the at least one opening on either or both sides of the vehicle.

### FIELD OF THE INVENTION

The embodiments described herein relate generally to providing one or more third-row doors for vehicles and more particularly to providing one or more third-row doors for vehicles such as a minivan, a sports utility vehicle (SUV), or a multipurpose vehicle (MPV).

### SUMMARY

In one or more embodiments, systems, and methods for providing one or more third-row doors for a vehicle and a vehicle including one or more third-row doors are disclosed.

In one or more embodiments, the system and method for providing one or more third-row doors for a vehicle, the vehicle including a vehicle frame having at least one opening for at least one third-row door, wherein the system comprises at least one third-row door provided on either or both sides of the vehicle.

In one or more embodiments, the system and method for providing one or more third-row doors for a vehicle as at least one third-row door for a vehicle comprises a door that is provided as a fourth door on one side of the third row of seats.

In one or more embodiments, the system and method for providing a third-row door for a vehicle includes a door that is provided as a fourth door on one side of the third row of seats.

In one or more embodiments, the system and method for providing a third-row door as a fourth door on one side of the third row of seats for a vehicle includes a left swing door or a right swing door.

In one or more embodiments, the system and method for providing a third-row door as a fourth door on one side of the third row of seats for a vehicle includes a French double door.

In one or more embodiments, the system and method for providing a third-row door as a fourth door on one side of the third row of seats for a vehicle includes a falcon door.

In one or more embodiments, the system and method for providing a third-row door as a fourth door on one side of the third row of seats for a vehicle includes a sliding door that slides from the third row to a second row of seats.

In one or more embodiments, the system and method for providing one or more third-row doors for a vehicle includes one or more doors that are provided as third and/or fourth door on one or both sides of the vehicle between a second row and the third row of seats.

In one or more embodiments, the system and method for providing one or more third-row doors for a vehicle that is provided as a third and/or fourth door on one or both sides of the vehicle between a second row and the third row of seats includes a left swing door or a right swing door.

In one or more embodiments, the system and method for providing one or more third-row doors for a vehicle that is provided as a third and/or fourth door on one or both sides of the vehicle between a second row and the third row of seats includes a French double door.

In one or more embodiments, the system and method for providing one or more third-row doors for a vehicle that is provided as a third and/or fourth door on one or both sides of the vehicle between a second row and the third row of seats includes a falcon door.

In one or more embodiments, the system and method for providing one or more third-row doors for a vehicle that is provided as a third and/or fourth door on one or both sides of the vehicle between a second row and the third row of seats includes a sliding door that slides between a third row of seats and a second row of seats in either direction, for example, third row of seats to second row of seats or second row of seats to third row of seats.

In one or more embodiments, the vehicle including one or more third-row doors includes at least one third-row door provided on either or both sides of the vehicle, the vehicle including a vehicle frame having at least one opening for at least one third-row door.

In one or more embodiments, the vehicle including one or more third-row doors as at least one third-row door for a vehicle includes a door that is provided as a fourth door on one side of the third row of seats.

In one or more embodiments, the vehicle including a third-row door for a vehicle includes a door that is provided as a fourth door on one side of the third row of seats.

In one or more embodiments, the vehicle including a third-row door for a vehicle includes a door that is provided as a fourth door on one side of the third row of seats for a vehicle includes a left swing door or a right swing door.

In one or more embodiments, the vehicle including a third-row door for a vehicle includes a door that is provided as a fourth door on one side of the third row of seats for a vehicle includes a French double door.

In one or more embodiments, the vehicle including a third-row door for a vehicle includes a door that is provided as a fourth door on one side of the third row of seats for a vehicle includes a falcon door.

In one or more embodiments, the vehicle including a third-row door for a vehicle includes a door that is provided as a fourth door on one side of the third row of seats for a vehicle includes a sliding door that slides from the third row to a second row of seats.

In one or more embodiments, the vehicle including one or more third-row doors for a vehicle includes one or more doors that are provided as third and/or fourth door on one or both sides of the vehicle between a second row and the third row of seats.

In one or more embodiments, the vehicle including one or more third-row doors for a vehicle that is provided as a third and/or fourth door on one or both sides of the vehicle between a second row and the third row of seats includes a left swing door or a right swing door.

In one or more embodiments, the vehicle including one or more third-row doors for a vehicle that is provided as a third and/or fourth door on one or both sides of the vehicle between a second row and the third row of seats includes a French double door.

In one or more embodiments, the vehicle including one or more third-row doors for a vehicle that is provided as a third and/or fourth door on one or both sides of the vehicle between a second row and the third row of seats includes a falcon door.

In one or more embodiments, the vehicle including one or more third-row doors for a vehicle that is provided as a third and/or fourth door on one or both sides of the vehicle between a second row and the third row of seats includes a sliding door that slides between a third row of seats and a second row of seats in either direction, for example, third row of seats to second row of seats or second row of seats to third row of seats.

### BRIEF DESCRIPTION OF THE DRAWINGS

FIGS. 1A and 1B illustrate an example system including a third-row door for a vehicle according to one or more embodiments described herein.

FIGS. 2A and 2B illustrate an example system including a third-row door for a vehicle according to one or more embodiments described herein.

FIGS. 3A and 3B illustrate exemplary methods for providing a third-row door for vehicle according to one or more embodiments described herein.

### DETAILED DESCRIPTION

The embodiments described herein relate generally to providing one or more third-row doors for vehicles and more particularly to providing one or more third-row doors for vehicles such as a minivan, a sports utility vehicle (SUV), or a multipurpose vehicle (MPV).

The following description is presented to enable one of ordinary skill in the art to make and use the invention and is provided in the context of a patent application and its requirements. Various modifications to the preferred embodiments and the generic principles and features described herein will be readily apparent to those skilled in the art. Thus, the present invention is not intended to be limited to the embodiments shown, but is to be accorded the widest scope consistent with the principles and features described herein.

The following embodiments described herein are unique and improved methods/devices that provide one or more third-row doors for vehicles such as a minivan, a sports utility vehicle (SUV), or a multipurpose vehicle (MPV).

In one or more embodiments, system, and method for providing one or more third-row door for vehicle are disclosed.

In one or more embodiments, the system and method for providing one or more third-row doors for a vehicle, the vehicle including a vehicle frame having at least one opening for at least one third-row door, wherein the system comprises at least one third-row door provided on either or both sides of the vehicle.

In one or more embodiments, the system and method for providing one or more third-row doors for a vehicle as at least one third-row door for a vehicle comprises a door that is provided as a fourth door on one side of the third row of seats.

In one or more embodiments, the system and method for providing a third-row door as a fourth door on one side of the third row of seats for a vehicle includes a left swing door or a right swing door depending on the side of the vehicle and the point of attachment of the door to the vehicle. For example, for a third-row door installed on the passenger side of the vehicle, the left swing door may be attached to the vehicle frame with a hinge position at the opening of the vehicle frame near a third row of seats when viewed facing towards the vehicle from outside, and wherein the right swing door may be attached to the vehicle frame with a hinge position at an opening of the vehicle frame near a second row of seats when viewed facing towards the vehicle from outside.

In one or more embodiments, the system and method for providing a third-row door as a fourth door on one side of the third row of seats for a vehicle includes a French double door, wherein the French double door is attached to the vehicle frame with hinges positioned at the opening of the vehicle frame on either side of door and is provided with a door closure.

In one or more embodiments, the system and method for providing a third-row door as a fourth door on one side of the third row of seats for a vehicle includes a falcon door, wherein the falcon door is attached to the vehicle frame with a hinge position at an opening of the vehicle frame at the top of the door.

In one or more embodiments, the system and method for providing a third-row door as a fourth door on one side of the third row of seats for a vehicle includes a sliding door that slides from the third row of seats to a second row of seats.

In one or more embodiments, the system and method for providing a third-row door for a vehicle includes a door that is provided as a third and/or fourth door on one or both sides of the vehicle between a second row of seats and the third row of seats.

In one or more embodiments, the system and method for providing a third-row door for a vehicle that is provided as a third and/or fourth door on one or both sides of the vehicle includes a left swing door or a right swing door depending on the side of the vehicle and/or the point of attachment of the door to the vehicle frame, wherein the door is attached to the vehicle frame with hinge position at an opening of the vehicle frame at the third row of seats or the second row of seats.

In one or more embodiments, the system and method for providing a third-row door for a vehicle that is provided as a third and/or fourth door on one or both sides of the vehicle includes a French double door, wherein the French double door is attached to the vehicle frame with hinges positioned at an opening of the vehicle frame at the second row of seats and at the third row of seats, and is provided with a door closure.

In one or more embodiments, the system and method for providing a third-row door for a vehicle that is provided as a third and/or fourth door on one or both sides of the vehicle includes a falcon door, wherein the falcon door is attached to the vehicle frame with a hinge positioned at an opening of the vehicle frame at the top of the door.

In one or more embodiments, the system and method for providing a third-row door for a vehicle that is provided as a third and/or fourth door on one or both sides of the vehicle includes a sliding door that slides between a third row of seats and a second row of seats in either direction, for example, third row of seats to second row of seats or second row of seats to third row of seats.

In one or more embodiments, the vehicle including one or more third-row doors includes at least one third-row door provided on either or both sides of the vehicle.

In one or more embodiments, the vehicle including one or more third-row doors as at least one third-row door for a vehicle includes a door that is provided as a fourth door on one side of the third row of seats.

In one or more embodiments, the vehicle including a third-row door for a vehicle includes a door that is provided as a fourth door on one side of the third row of seats.

In one or more embodiments, the vehicle including a third-row door for a vehicle includes a door that is provided as a fourth door on one side of the third row of seats for a vehicle includes a left swing door or a right swing door, wherein the left swing door is attached to the vehicle frame with a hinge position at the opening of the vehicle frame to a third row of seats and wherein the right swing door is attached to the vehicle frame with a hinge position at an opening of the vehicle frame to a second row of seats.

In one or more embodiments, the vehicle including a third-row door for a vehicle includes a door that is provided as a fourth door on one side of the third row of seats for a vehicle includes a French double door, wherein the French double door is attached to the vehicle frame with hinges positioned at the opening of the vehicle frame on either side of door and is provided with a door closure.

In one or more embodiments, the vehicle including a third-row door for a vehicle includes a door that is provided as a fourth door on one side of the third row of seats for a vehicle includes a falcon door, wherein the falcon door is attached to the vehicle frame with a hinge position at an opening of the vehicle frame at the top of the door.

In one or more embodiments, the vehicle including a third-row door for a vehicle includes a door that is provided as a fourth door on one side of the third row of seats for a vehicle includes a sliding door that slides from the third row to a second row of seats.

In one or more embodiments, the vehicle including one or more third-row doors for a vehicle includes a door that is provided as a third and/or fourth door on one or both sides of the vehicle between a second row and the third row of seats.

In one or more embodiments, the vehicle including one or more third-row doors for a vehicle that is provided as a third and/or fourth door on one or both sides of the vehicle between a second row and the third row of seats includes a left swing door or a right swing door depending on the side of the vehicle and/or the point of attachment of the door to the vehicle, wherein the door is attached to the vehicle frame with hinge position at an opening of the vehicle frame at the third row of seats or the second row of seats.

In one or more embodiments, the vehicle including one or more third-row doors for a vehicle that is provided as a third and/or fourth door on one or both sides of the vehicle between a second row and the third row of seats includes a French double door, wherein the French double door is attached to the vehicle frame with hinges positioned at an opening of the vehicle frame at the second row of seats and at the third row of seats, and is provided with a door closure.

In one or more embodiments, the vehicle including one or more third-row doors for a vehicle that is provided as a third and/or fourth door on one or both sides of the vehicle between a second row and the third row of seats includes a falcon door, wherein the falcon door is attached to the vehicle frame with a hinge positioned at an opening of the vehicle frame at the top of the door.

In one or more embodiments, the vehicle including one or more third-row doors for a vehicle that is provided as a third and/or fourth door on one or both sides of the vehicle between a second row and the third row of seats includes a sliding door that slides between a third row of seats and a second row of seats in either direction, for example, third row of seats to second row of seats or second row of seats to third row of seats.

The purpose of this device/system and method is to provide a third-row door for vehicles such as a minivan, a sports utility vehicle (SUV), or a multipurpose vehicle (MPV) without compromising efficacy of use as well as safety and aesthetics of the vehicle. A person skilled in the art may readily understand that this device/method could be utilized in a multitude of configurations and is within the spirit and scope of the present invention described herein.

Traditionally various different types of doors are provided to vehicles with a third row of seats, many of them involving bending and maneuvering to the third-row seats, which makes it difficult for adults to access the third-row seats either for them to use those seats or to access those seats for children, for example, installing a child seat or buckling a child seating in a child seat. In most existing three row vehicles' fourth door only adds another access to the second row which third door already provides. Difficulties of getting into third row for adults and/or children still remains. Vehicles such as stretched limousines use doors that match the vehicles from which the stretched limousines are built by keeping the front end and back end of the vehicle the same where the middle portion is extended. Vehicles with doors in addition to the regular four doors have also been made to overcome the issues described above but they are not aesthetically pleasing, cost efficient, or effective in providing ingress or egress from the third-row seats.

The method and system described herein provides a third-row door for vehicles and more particularly to a third-row door for vehicles such as a minivan, a sports utility vehicle (SUV), or a multipurpose vehicle (MPV), wherein the third-row door replaces one of the second-row doors, thereby making it easier for adults as well as children to access the third-row seats without bending or inconvenient maneuvering and without compromising safety of the vehicle.

The device/system according to one or more embodiments described herein includes a third-row door for vehicles and more particularly to a third-row door for vehicles such as a minivan, a sports utility vehicle (SUV), or a multipurpose vehicle (MPV).

The device/system according to one or more embodiments described herein makes it easier for people to access the third row, cost efficient to make, and provides better functionality and aesthetically pleasing.

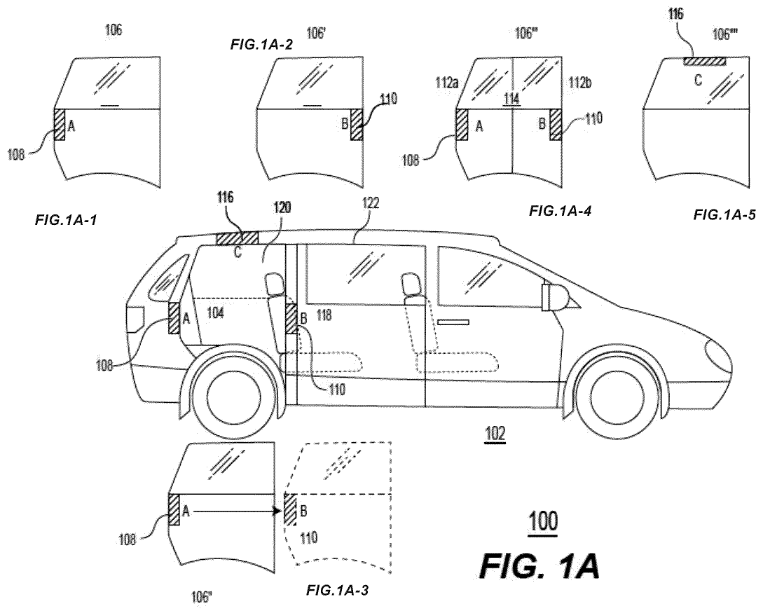

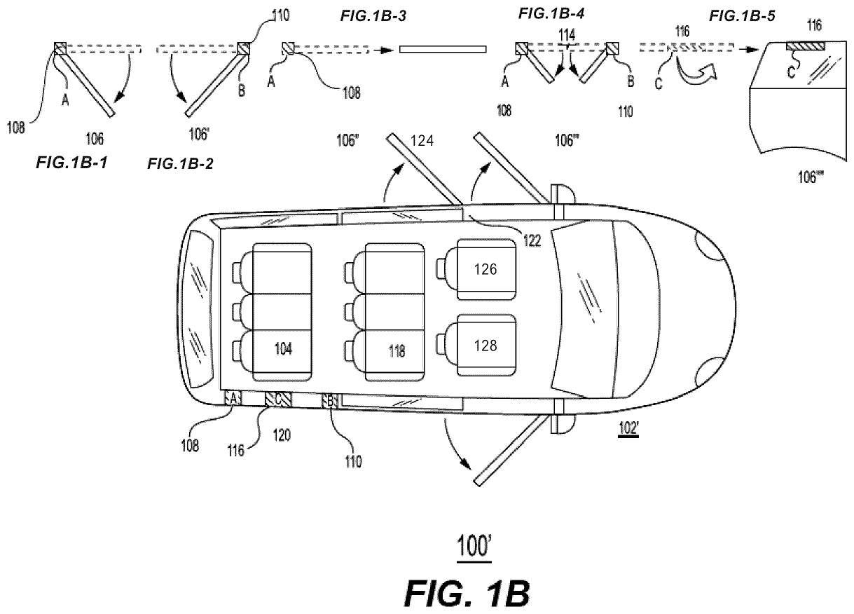

FIGS. 1A and 1B illustrate an example system 100 and 100′ for providing a third-row door for a vehicle 102 and 102′ respectively or a vehicle 102 and 102′ including a third-row door according to one or more embodiments described herein. For example, FIG. 1A illustrates a side view of the system and method 100 for providing a third-row door for a vehicle 102 or a vehicle 102 including a third-row door includes a door that is provided as a fourth door on one side of the third row of seats 104 according to one or more embodiments described herein.

For example, in one or more embodiments, the system for providing a third-row door for a vehicle 102 or a vehicle 102 including a third-row door 106 and/or 106′ as a fourth door on one side of the third row of seats 104 for a vehicle 102 includes a left swing door 106 that is attached to the vehicle frame 122 with a hinge A 108, positioned on the vehicle frame 122 at the third row of seats 104, or a right swing door 106′ that is attached to the vehicle frame 122 with a hinge B 110, positioned on the vehicle frame 122 at a second row of seats 118, as illustrated in FIG. 1A. The hinge 108 may be located at the aft of the center position of the rear wheel well and the hinge 110 may be located forward of the center position of the rear wheel well allowing easy ingress and egress to the third row of seats 104 and second row of seats 118.

Thus, in one or more embodiments, the system and method for providing a third-row door as a fourth door on one side of the third row of seats for a vehicle may include a left swing door 106 or a right swing door 106′ depending on the side of the vehicle and the point of attachment of the door to the vehicle 102. For example, for a third-row door installed on the passenger side of the vehicle, the left swing door 106 may be attached to the vehicle frame 122 with a hinge position A 108 at the opening of the vehicle frame near a third row of seats 104 when viewed facing towards the vehicle 102 from outside, and wherein the right swing door 106′ may be attached to the vehicle frame 122 with a hinge position B 110 at an opening of the vehicle frame 122 near a second row of seats 118 when viewed facing towards the vehicle 102 from outside. Similarly, for example, for a third-row door installed on the driver side of the vehicle, the left swing door 106 may be attached to the vehicle frame 122 with a hinge position A 110 at the opening of the vehicle frame near a second row of seats 118 when viewed facing towards the vehicle 102 from outside, and wherein the right swing door 106′ may be attached to the vehicle frame 122 with a hinge position B 108 at an opening of the vehicle frame 122 near a third row of seats 118 when viewed facing towards the vehicle 102 from outside.

In another embodiment, the system for providing a third-row door for a vehicle 102 or a vehicle 102 including a third-row door 106′″ as a fourth door on one side of the third row of seats 104 for a vehicle 102 includes a French double door 112a and 112b that is attached to the vehicle frame 122 with hinges A 108 and B 110 respectively that are positioned on the vehicle frame 122 on either side of door, and a door closure 114 as illustrated in FIG. 1A. The hinge A 108 may be located aft of the center position of the rear wheel well and the hinge B 110 may be located forward of the center position of the rear wheel well allowing easy ingress and egress to the third row of seats 104 and second row of seats 118.

In yet another embodiment, the system for providing a third-row door for a vehicle 102 or a vehicle 102 including a third-row door 106′″ as a fourth door on one side of the third row of seats 104 for a vehicle 102 includes an upwardly swinging falcon door 106″″ that is attached to the vehicle frame 122 with a hinge C 116 positioned on the vehicle frame 122 at the top of the door, as illustrated in FIG. 1A. The hinge C 116 may be located at or near the center line of the rear wheel well allowing easy ingress and egress to the third row of seats 104 and second row of seats 118.

In another embodiment, the system for providing a third-row door for a vehicle 102 or a vehicle 102 including a third-row door 106″ as a fourth door on one side of the third row of seats 104 for a vehicle 102 includes a sliding door 106″ that slides from the third row of seats 104 to a second row of seats 118, for example, from hinge A 108 to hinge B 110, allowing easy ingress and egress to the third row of seats 104 and second row of seats 118, as illustrated in FIG. 1A.

The hinges A 108, B 110 and C 116 illustrated on the doors 106, 106′, 106″, 106′″ and 106″″ are for illustrating the point of attachments for the doors to the respective hinges on the vehicle frame 122 when the door is attached to the vehicle frame 122 on a passenger side of the vehicle 102.

FIG. 1B illustrates a top view of the system 100′ for providing a third-row door for a vehicle 102′ or a vehicle 102′ including a third-row door includes a door that is provided as a fourth door on one side of the third row of seats 104 allowing easy ingress and egress to the third row of seats 104 and second row of seats 118 according to one or more embodiments described herein.

For example, in one or more embodiments, the system for providing a third-row door for a vehicle 102′ or a vehicle 102′ Including a third-row door 106 and/or 106′ as a fourth door on one side of the third row of seats 104 for a vehicle 102 includes a left swing door 106 that is attached to the vehicle frame 122 with a hinge A 108, positioned on the vehicle frame 122 at the third row of seats 104, or a right swing door 106′ that is attached to the vehicle frame 122 with a hinge B 110, positioned on the vehicle frame 122 at a second row of seats 118, as illustrated in FIG. 1B. The hinge A 108 may be located aft of the center position of the rear wheel well and the hinge B 110 may be located forward of the center position of the rear wheel well allowing easy ingress and egress to the third row of seats 104 and second row of seats 118.

Thus, in one or more embodiments, the system and method for providing a third-row door as a fourth door on one side of the third row of seats for a vehicle may include a left swing door 106 or a right swing door 106′ depending on the side of the vehicle and the point of attachment of the door to the vehicle 102′. For example, for a third-row door installed on the passenger side 128 of the vehicle, the left swing door 106 may be attached to the vehicle frame 122 with a hinge position A 108 at the opening of the vehicle frame near a third row of seats 104 when viewed facing towards the vehicle 102 from outside, and wherein the right swing door 106′ may be attached to the vehicle frame 122 with a hinge position B 110 at an opening of the vehicle frame 122 near a second row of seats 118 when viewed facing towards the vehicle 102 from outside. Similarly, for example, for a third-row door installed on the driver side 126 of the vehicle, the left swing door 106 may be attached to the vehicle frame 122 with a hinge position B 110 at the opening of the vehicle frame near a second row of seats 118 when viewed facing towards the vehicle 102′ from outside, and wherein the right swing door 106′ may be attached to the vehicle frame 122 with a hinge position A 108 at an opening of the vehicle frame 122 near a third row of seats 118 when viewed facing towards the vehicle 102′ from outside.

In another embodiment, the system for providing a third-row door for a vehicle 102′ or a vehicle 102′ Including a third-row door 106′″ as a fourth door on one side of the third row of seats 104 for a vehicle 102′ includes a French double door 106′″ including 112a and 112b that is attached to the vehicle frame 122 with hinges A 108 and B 110 positioned on the vehicle frame 122 on either side of door respectively, and the door closure 114, as illustrated in FIG. 1B. The hinge A 108 may be located aft of the center position of the rear wheel well and the hinge B 110 may be located forward of the center position of the rear wheel well allowing easy ingress and egress to the third row of seats 104 and second row of seats 118.

In yet another embodiment, the system for providing a third-row door for a vehicle 102′ or a vehicle 102′ including a third-row door 106″″ as a fourth door on one side of the third row of seats 104 for a vehicle 102′ includes an upwardly swinging falcon door 106″″ that is attached to the vehicle frame 122 with a hinge C 116 positioned on the vehicle frame 122 at the top of the door, as illustrated in FIG. 1B. The hinge C 116 may be located at or near the center line of the rear wheel well allowing easy ingress and egress to the third row of seats 104 and second row of seats 118.

In another embodiment, the system for providing a third-row door for a vehicle 102′ or a vehicle 102′ including a third-row door 106″ as a fourth door on one side of the third row of seats 104 for a vehicle 102′ includes a sliding door 106″ that slides from the third row of seats 104 to a second row of seats 118, for example, from hinge A 108 to hinge B 110, allowing easy ingress and egress to the third row of seats 104 and second row of seats 118, as illustrated in FIG. 1B.

The hinges A 108, B 110 and C 116 illustrated on the doors 106, 106′, 106″. 106′″ and 106″″ are for illustrating the point of attachments for the doors to the respective hinges on the vehicle 122 when the door is attached to the vehicle frame 122 on a passenger side 128 of the vehicle 102′.

In any of the embodiments described above and illustrated in FIGS. 1A and 1B, the third-row door may be provided on the opposite side of the second-row door 124 as illustrated in FIG. 1B. As illustrated in FIG. 1B, the second-row door may be provided on the driver-side 126 of the vehicle and the third-row door may be provided on the passenger-side 128 of the vehicle. Alternatively, both the second-row door and the third-row door may be provided on the passenger-side 128 of the vehicle.

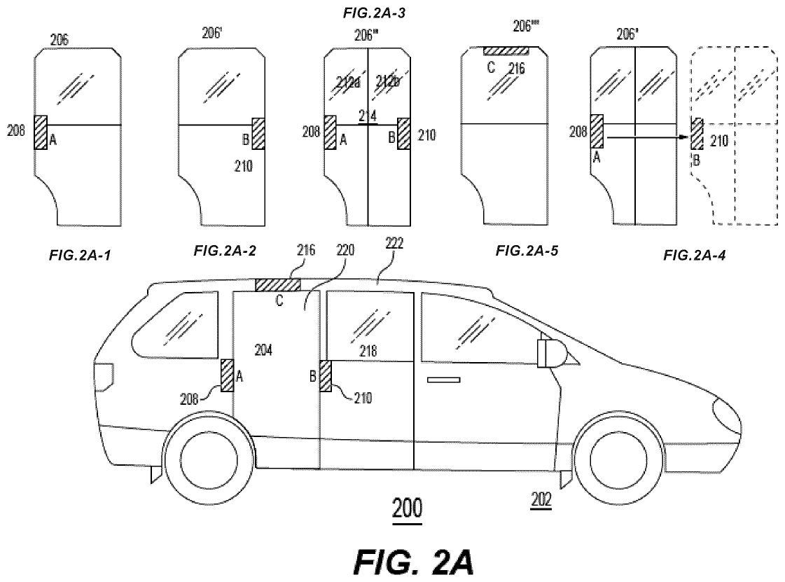

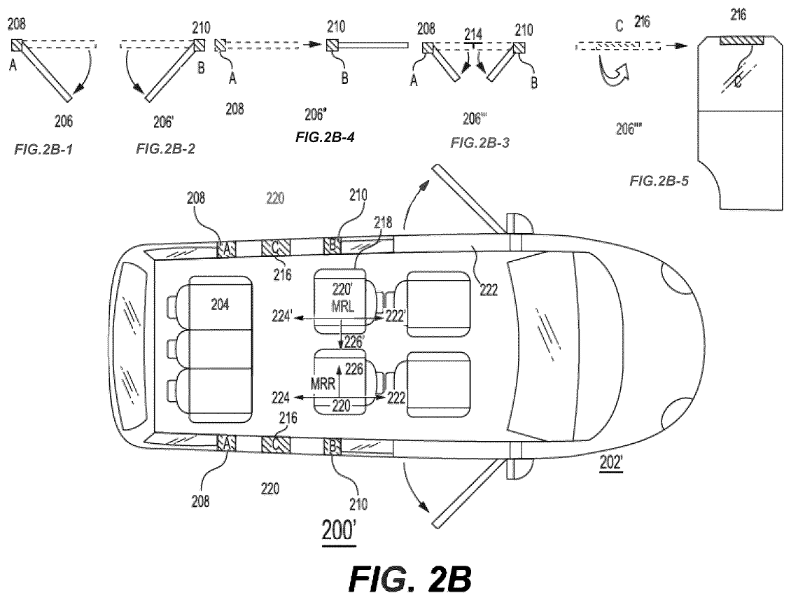

FIGS. 2A and 2B illustrate an example system 200 and 200′ for providing one or more third-row doors for a vehicle that is provided as a third and/or fourth door on one or both sides of the vehicle 202 and 202′ respectively or a vehicle 202 and 202′ including one or more third-row doors for a vehicle according to one or more embodiments described herein. For example, FIG. 2A illustrates a side view of the system 200 and vehicle 202 with one or more third-row doors for a vehicle includes a door that is provided as a third and/or fourth door on one or both sides of the vehicle 202 between a second row of seats 218 and the third row of seats 204.

In one or more embodiments, the system for providing one or more third-row doors for a vehicle that is provided as a third and/or fourth door on one or both sides of the vehicle 202 or a vehicle 202 with one or more third-row doors for a vehicle that is provided as a third and/or fourth door on one or both sides of the vehicle includes: a left swing door 206 or a right swing door 206′ depending on the side of the vehicle 202 and/or the point of attachment of the door to the vehicle, and is attached to the vehicle frame 222 with a hinge A 208 or hinge B 210 positioned on the vehicle frame 222 at the third row of seats or second row of seats, respectively. The hinge A 208 and hinge B 210 may both be located forward of the center position of the rear wheel well allowing easy ingress and egress to the third row of seats 204 and second row of seats 218.

Additionally or alternatively, the third and/or fourth door may be attached at the third row of seats on one side and the second row of seats on the other side of the vehicle or vice versa, or at the third row of seats on both sides, or at the second row of seats on both sides of the vehicle. A person skilled in the art may readily understand that various combinations provided herein are for example only and other combinations achieving a similar effect are also within the spirit and scope of this invention.

In another embodiment, the system 200 for providing one or more third-row doors for a vehicle that is provided as a third and/or fourth door on one or both sides of the vehicle 202 or a vehicle 202 including one or more third-row doors for a vehicle that is provided as a third and/or fourth door on one or both sides of the vehicle includes: a French double door 206′″ including doors 212a and 212b that is attached to the vehicle frame 222 with hinges A 208 and B 210 positioned on the vehicle frame 222 on either side of the door respectively, and the door closure 214 as illustrated in FIG. 2A. The hinges A 208 and B 210 may both be located forward of the center position of the rear wheel well allowing easy ingress and egress to the third row of seats 204 and second row of seats 218.

In yet another embodiment, the system 200 for providing one or more third-row doors for a vehicle that is provided as a third and/or fourth door on one or both sides of the vehicle 202 or a vehicle 202 including one or more third-row doors for a vehicle that is provided as a third and/or fourth door on one or both sides of the vehicle includes: an upwardly swinging falcon door 206″″ that is attached to the vehicle frame 222 with hinge C 216 positioned on the vehicle frame 222 at the top of the door. The hinge C 216 may be located forward of the center line of the rear wheel well allowing easy ingress and egress to the third row of seats 204 and second row of seats 218.

In another embodiment, the system for providing one or more third-row doors for a vehicle that is provided as a third and/or fourth door on one or both sides of the vehicle 202 or a vehicle 202 including one or more third-row doors for a vehicle that is provided as a third and/or fourth door on one or both sides of the vehicle includes: a sliding door 206″ that slides between a third row of seats 204 and a second row of seats 218 in either direction, for example, from third row of seats 204 to second row of seats 218, for example, from hinge A 108 to hinge B 110, or from second row of seats 218 to third row of seats 204, for example, from hinge B 110 to hinge A 108, allowing easy ingress and egress to the third row of seats 204 and second row of seats 218.

The hinges A 208, B 210 and C 216 illustrated on the doors 206, 206′, 206″, 206′″ and 206″″ are for illustrating the point of attachments for the doors to the respective hinges on the vehicle frame 222.

FIG. 2B illustrates a top view of the system 200′ for providing one or more third-row doors for a vehicle that is provided as a third and/or fourth door on one or both sides of the vehicle 202′ or a vehicle 202′ including one or more third-row doors for a vehicle includes a door that is provided as a third and/or fourth door on one or both sides of the vehicle 202 between a second row of seats 218 and the third row of seats 204.

In one or more embodiments, the system 200′ for providing one or more third-row doors for a vehicle that is provided as a third and/or fourth door on one or both sides of the vehicle 202′ or a vehicle 202′ including one or more third-row doors for a vehicle that is provided as a third and/or fourth door on one or both sides of the vehicle includes a left swing door 206 and/or a right swing door 206′, depending on the side of the vehicle 202 and/or the point of attachment of the door to the vehicle, that is attached to the vehicle frame 222 with and hinge A 208 or hinge B 210 positioned on the vehicle frame 222 at the third row of seats or second row of seats, respectively. The hinge A 208 and hinge B 210 may both be located forward of the center position of the rear wheel well allowing easy ingress and egress to the third row of seats 204 and second row of seats 218.

Additionally or alternatively, the third and/or fourth door may be attached at the third row of seats on one side and the second row of seats on the other side of the vehicle or vice versa, or at the third row of seats on both sides, or at the second row of seats on both sides of the vehicle. A person skilled in the art may readily understand that various combinations provided herein are for example only and other combinations achieving a similar effect are also within the spirit and scope of this invention.

In another embodiment, the system 200′ for providing one or more third-row doors for a vehicle that is provided as a third and/or fourth door on one or both sides of the vehicle 202′ or a vehicle 202′ including one or more third-row doors for a vehicle that is provided as a third and/or fourth door on one or both sides of the vehicle includes, for example, a French double door 206′″ including doors 212a and 212b that is attached to the vehicle frame 222 with hinge A 208 positioned at the third-row of seats on the vehicle frame 222 and hinge B 210 positioned at the second-row of seats on the vehicle frame 222, and the door closure 214 as illustrated in FIGS. 2A and 2B. The hinges A 208 and B 210 may both be located forward of the center position of the rear wheel well allowing easy ingress and egress to the third row of seats 204 and second row of seats 218. Further, a second French double door 206′″ may be provided on the other side of the vehicle 202′ (not shown).

In yet another embodiment, the system 200′ for providing one or more third-row doors for a vehicle that is provided as a third and/or fourth door on one or both sides of the vehicle or a vehicle 202′ including one or more third-row doors for a vehicle that is provided as a third and/or fourth door on one or both sides of the vehicle includes an upwardly swinging falcon door 206″″ that is attached to the vehicle frame 222 with hinge 216 positioned on the vehicle frame 222 at the top of the door. The hinge C 216 may be located forward of the center line of the rear wheel well allowing easy ingress and egress to the third row of seats 204 and second row of seats 218. Further, a second Falcon door 206″″ may be provided on the other side of the vehicle 202′ (not shown).

In another embodiment, the system 200′ for providing one or more third-row doors for a vehicle that is provided as a third and/or fourth door on one or both sides of the vehicle 202′ or a vehicle 202′ including one or more third-row doors for a vehicle that is provided as a third and/or fourth door on one or both sides of the vehicle includes a sliding door 206″ that slides between a third row of seats 204 and a second row of seats 218 in either direction, for example, third row of seats 204 to second row of seats 218 or second row of seats 218 to third row of seats 204 allowing easy ingress and egress to the third row of seats 204 and second row of seats 218. Further, a second sliding door 206″ may be provided on the other side of the vehicle 202 (not shown).

The second row of seats 218, for example, middle row right (MRR) seat 220 and middle row left (MRL) seat 220′, in any of the embodiments described herein may be designed as forward facing 222 and 222′, rear facing 224 and 224′ or side facing towards each other 226 and 226′ and may be turnable around its own axis, capable of moving fore and aft, and lockable in place in three directions 222, 224, and 226, and 222′, 224′, and 226′ when desired position is reached.

The hinges A 208, B 210 and C 216 illustrated on the doors 206, 206′, 206″, 206′″ and 206″″ are for illustrating the point of attachments for the doors to the respective hinges on the vehicle frame 222.

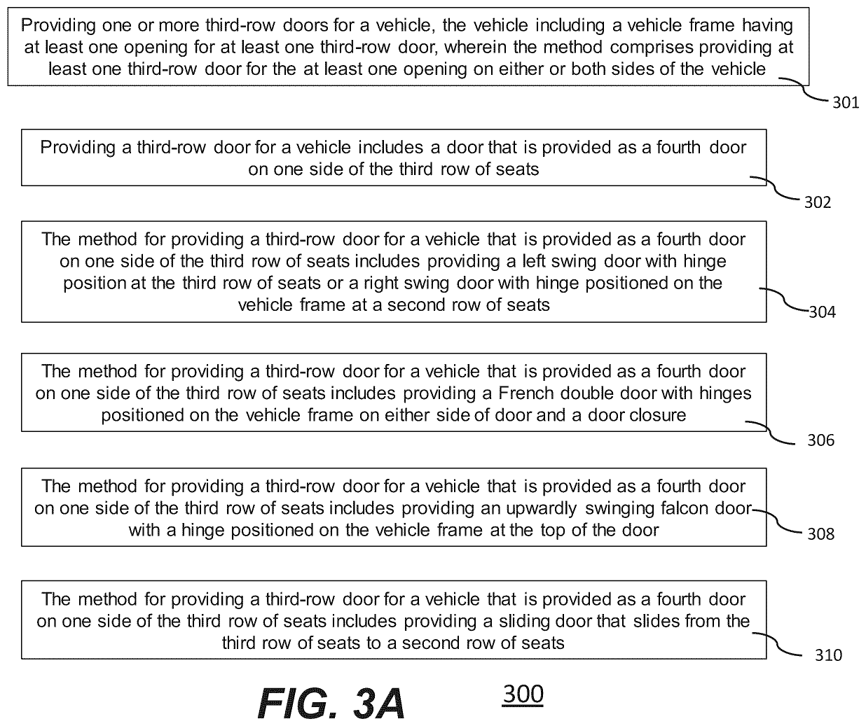

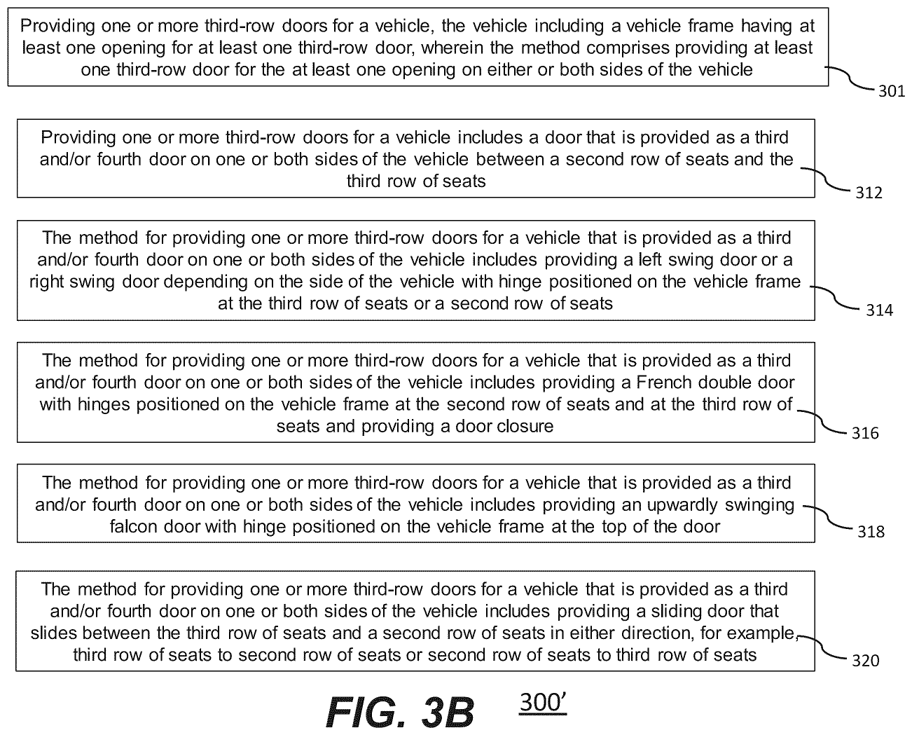

FIG. 3A illustrates an example method 300 for providing a third-row door for vehicle according to one or more embodiments described herein. The method 300 for providing one or more third-row doors for a vehicle, wherein the vehicle includes a vehicle frame having at least one opening for at least one third-row door, and wherein the method comprises providing at least one third-row door for the at least one opening on either or both sides of the vehicle via step 301.

The method 300 for providing a third-row door for vehicle further includes a door that is provided as a fourth door on one side of the third row of seats via step 302.

In one or more embodiments, the method for providing a third-row door for a vehicle that is provided as a fourth door on one side of the third row of seats includes providing a left swing door that is attached to the vehicle frame with hinge positioned on the vehicle frame at the third row of seats or a right swing door with a hinge positioned on the vehicle frame at a second row of seats via step 304.

In one or more embodiments, the method for providing a third-row door for a vehicle that is provided as a fourth door on one side of the third row of seats includes providing a French double door that is attached to the vehicle frame with a hinge positioned on the vehicle frame on either side of door and providing a door closure via step 306.

In one or more embodiments, the method for providing a third-row door for a vehicle that is provided as a fourth door on one side of the third row includes providing an upwardly swinging falcon door that is attached to the vehicle frame with a hinge positioned on the vehicle frame at the top of the door via step 308.

In one or more embodiments, the method for providing a third-row door for a vehicle that is provided as a fourth door on one side of the third row of seats includes providing a sliding door that slides from the third row of seats to a second row of seats via step 310.

FIG. 3B illustrates an example method 300′ for providing one or more third-row doors for a vehicle according to one or more embodiments described herein. The method 300′ for providing one or more third-row doors for a vehicle, wherein the vehicle includes a vehicle frame having at least one opening for at least one third-row door, and wherein the method comprises providing at least one third-row door for the at least one opening on either or both sides of the vehicle via step 301.

The method 300′ for providing one or more third-row doors for a vehicle further includes a door that is provided as a third and/or fourth door on one or both sides of the vehicle between a second row of seats and the third row of seats via step 312.

In one or more embodiment, the method for providing one or more third-row doors for a vehicle that is provided as a third and/or fourth door on one or both sides of the vehicle includes providing a left swing door or a right swing door, depending on the side of the vehicle and/or the point of attachment of the door to the vehicle, that is attached to the vehicle frame with a hinge positioned on the vehicle frame at the third row of seats or second row of seats via step 314.

Additionally or alternatively, the third and/or fourth door may be attached at the third row of seats on one side and the second row of seats on the other side of the vehicle or vice versa, or at the third row of seats on both sides, or at the second row of seats on both sides of the vehicle. A person skilled in the art may readily understand that various combinations provided herein are for example only and other combinations achieving a similar effect are also within the spirit and scope of this invention.

In one or more embodiment, the method for providing one or more third-row doors for a vehicle that is provided as a third and/or fourth door on one or both sides of the vehicle includes providing a French double door that is attached to the vehicle frame with hinges positioned on the vehicle frame at the second row and at the third row and providing a door closure via step 316.

In one or more embodiment, the method for providing one or more third-row doors for a vehicle that is provided as a third and/or fourth door on one or both sides of the vehicle includes providing an upwardly swinging falcon door that is attached to the vehicle frame with a hinge positioned on the vehicle frame at the top of the door via step 318.

In one or more embodiment, the method for providing one or more third-row doors for a vehicle that is provided as a third and/or fourth door on one or both sides of the vehicle includes providing a sliding door that slides between the third row of seats and a second row of seats in either direction, for example, third row of seats to second row of seats or second row of seats to third row of seats via step 320.

The method for providing one or more third-row doors for a vehicle described herein for any of the embodiments described above may further include providing the second-row seats, for example, middle row right seat and middle row left seat, as forward facing seats, rear facing seats or side facing seats facing towards each other, and may be turnable about its own axis, move fore and aft, and lockable in place in three directions when desired position is reached.

Any theory, mechanism of operation, proof, or finding stated herein is meant to further enhance understanding of the present invention and is not intended to make the present invention in any way dependent upon such theory, mechanism of operation, proof, or finding. It should be understood that while the use of the word preferable, preferably or preferred in the description above indicates that the feature so described may be more desirable, it nonetheless may not be necessary and embodiments lacking the same may be contemplated as within the scope of the invention, that scope being defined by the claims that follow.

As used herein the terms product, device, appliance, etc. are intended to be inclusive, interchangeable, and/or synonymous with one another and other similar equipment for purposes of the present invention though one will recognize that functionally each may have unique characteristics, functions and/or operations which may be specific to its individual capabilities.

Although the present invention has been described in accordance with the embodiments shown, one of ordinary skill in the art will readily recognize that there could be variations to the embodiments and those variations would be within the spirit and scope of the present invention. Accordingly, many modifications may be made by one of ordinary skill in the art without departing from the spirit and scope of the present invention.

We claim:

1. A system for providing one or more third-row doors for a vehicle with three rows of seats designed for use on road, wherein the system comprises a vehicle frame having at least one opening for at least one third-row door and at least one third-row door, wherein the at least one third-row door is provided for the at least one opening on either or both sides of the vehicle, and wherein the at least one third row door is provided for a third row of seats near rear wheel of the vehicle.

2. The system of claim 1, wherein the least one third-row door for a vehicle comprises a door that is provided as a fourth door for an opening on one side of the vehicle frame that opens to a third row of seats, wherein first and second doors correspond to a first row of seats, and third row door corresponds to a second row of seats.

3. The system of claim 2, wherein the least one third-row door for a vehicle comprises a left swing door or a right swing door depending on the point of attachment of the door to the vehicle.

4. The system of claim 2, wherein the least one third-row door for a vehicle comprises a French double door, wherein the French double door is attached to the vehicle frame with hinges positioned at the opening of the vehicle frame on either side of door and is provided with a door closure.

5. The system of claim 2, wherein the least one third-row door for a vehicle comprises a falcon door, wherein the falcon door is attached to the vehicle frame with a hinge position at an opening of the vehicle frame at the top of the door.

6. The system of claim 2, wherein the least one third-row door for a vehicle comprises a sliding door that slides from the third row of seats to a second row of seats.

7. The system of claim 1, wherein the least one third-row door for a vehicle comprises a door that is provided either as a third on one side of the vehicle, or as a third and a fourth door on both sides of the vehicle between a second row of seats and a third row of seats.

8. The system of claim 7, wherein the door that is provided as a third and/or fourth door on one or both sides of the vehicle between second row seats and third row seats comprises a left swing door or a right swing door depending on the side of the vehicle and a point of attachment of the door to the vehicle, wherein the door is attached to the vehicle frame with hinge position at any of: an opening of the vehicle frame at the third row of seats, the second row of seats, or a combination thereof.

9. The system of claim 7, wherein the door that is provided as a third and/or fourth door on one or both sides of the vehicle between second row of seats and third row of seats comprises French double door, wherein the French double door is attached to the vehicle frame with hinges positioned at an opening of the vehicle frame at the second row of seats and at the third row of seats, and is provided with a door closure.

10. The system of claim 7, wherein the door that is provided as a third and/or fourth door on one or both sides of the vehicle between second row of seats and third row of seats comprises a falcon door, wherein the falcon door is attached to the vehicle frame with a hinge positioned at an opening of the vehicle frame at the top of the door.

11. The system of claim 7, wherein the door that is provided as a third and/or fourth door on one or both sides of the vehicle between second row of seats and third row of seats comprises a sliding door that slides between the third row of seats and the second row of seats in either direction, such as, from the third row of seats to the second row of seats or from the second row of seats to the third row of seats.

12. A method for providing one or more third-row doors for a vehicle with three rows of seats designed for use on road, the method comprising providing for the at least one opening on either or both sides of the vehicle, wherein the at least one third row door is provided for a third row of seats near rear wheel of the vehicle.

13. The method of claim 12 comprising providing a third-row door for a vehicle that is provided as a fourth door for an opening on one side of the vehicle frame that opens to a third row of seats, wherein first and second doors correspond to a first row of seats, and third door corresponds to a second row of seats.

14. The method of claim 13 further comprising providing any of: a left swing door, a right swing door, a French double door, a falcon door or a sliding door that slides from the third row of seats to the second row of seats as a fourth door for an opening on one side of the vehicle frame.

15. The method of claim 12 comprising providing one or more third-row doors for a vehicle includes a door that is provided either as a third door on one side of the vehicle, or as a third and a fourth door on both sides of the vehicle between the second row of seats and the third row of seats.

16. The method of claim 15 further comprising providing any one or more of: a left swing door, a right swing door, a French double door, a falcon door and a sliding door that slides from the third row of seats to the second row of seats as a third and/or fourth door on one or both sides of the vehicle.

17. A vehicle with three rows of seats designed for use on road comprising a vehicle frame having at least one opening for at least one third-row door and at least one third-row door, wherein the at least one third-row door is provided for the at least one opening on either or both sides of the vehicle, and wherein the at least one third row door is provided for a third row of seats near rear wheel of the vehicle.

18. The vehicle of claim 17, wherein the least one third-row door for a vehicle comprises a door that is provided as a fourth door for an opening on one side of the vehicle frame that opens to a third row of seats, wherein first and second doors are provided for first row of seats and third door is provided for second row of seats.

19. The vehicle of claim 17, wherein the least one third-row door for a vehicle comprises a door that is provided either as a third door on one side of the vehicle, or as a third and a fourth door on both sides of the vehicle between a second row of seats and a third row of seats.
